(19) United States
(12) Patent Application Publication
(10) Pub. No.: US 2010/0263867 A1
(43) Pub. Date: Oct. 21, 2010

(54) UTILIZING ELECTROMAGNETIC RADIATION TO ACTIVATE FILTERCAKE BREAKERS DOWNHOLE

(76) Inventors: Amy C. Horton, St. Louis, MO (US); Robert L. Horton, Sugar Land, TX (US)

Correspondence Address: GORDON G. WAGGETT, P.C., 550 WESTCOTT STREET, SUITE 350, HOUSTON, TX, 77007-5099, US

(21) Appl. No.: 12/764,082

(22) Filed: Apr. 20, 2010

Related U.S. Application Data
(60) Provisional application No. 61/214,222, filed on Apr. 21, 2009.

(51) Int. Cl. E21B 37/08; C09K 8/524; E21B 43/02

(52) U.S. Cl. 166/292; 507/266; 507/269; 507/263; 507/209; 507/242; 507/139; 507/140; 507/137; 507/130; 507/101; 507/110; 166/300

(57) ABSTRACT

A downhole wellbore filtercake breaker is disclosed comprising one or more breaker chemicals (or activators thereof) capable of being activated with radiation to form one or more breaker reaction products which in turn are capable of reacting with the filtercake to chemically break down the filtercake. There is also disclosed a conventional reservoir drilling fluid modified to include an inactive, delayed, or sequestered breaker chemical or an activator thereof, wherein the breaker chemical (or activator) may be activated directly or indirectly by radiation, such as, microwave, visible, uV, soft x-ray, or other electromagnetic radiation. Also disclosed are methods for creating these filtercakes, and then breaking them via deploying a source of radiation that can be energized proximate to the filtercake. The breaker may be regenerated downhole by reaction with the filtercake breakdown products, and subjected again to a source of radiation to continue the breakdown of filtercake.

### CROSS-REFERENCE TO RELATED APPLICATIONS

This application claims the benefit of the filing date of and priority to U.S. Provisional Application Ser. No. 61/214,222 entitled “Utilizing electromagnetic radiation to activate filtercake breakers downhole” and filed Apr. 21, 2009, Confirmation No. 5260. Said provisional application is incorporated by reference herein.

### STATEMENT REGARDING FEDERALLY SPONSORED RESEARCH OR DEVELOPMENT

Not Applicable.

### BACKGROUND OF THE INVENTION

1. Field of the Invention

The invention relates generally to the construction of an oil, gas condensate, or gas well. In said well construction, typically a filtercake (also referred to as a filter cake, cake, mudcake, or wall cake) is laid down as a lining for the well in order that, by maintaining a fluid in the well of suitable density, the hydraulic pressure in the wellbore will keep said filtercake in place across the rock face with slightly greater pressure than any pressure encountered in any subterranean formations encountered in the course of constructing the well, thereby keeping the well continuously under control and preventing a blow-out and possibly a subsequent well fire. For the majority of the well, referred to as the “top-hole”, there is no need for subsequently breaking the filtercake; however, typically, when the top-hole construction is nearly complete, the top-hole drilling fluid is displaced from the well by a specially designed reservoir drilling fluid so the downhole or reservoir section of the well can be constructed while laying down a filtercake there which continues to keep the well under control, but which is more readily removed, preferably by a filtercake breaker which is inactive or relatively so until the time comes to complete the well and turn it on to production of the oil, gas condensate, or gas, whereupon it is desirable to activate the breaker and break the filtercake.

A filtercake is generally defined as the residue deposited on a permeable medium when a slurry, such as a drilling fluid, is forced against the medium under a pressure. Filtrate is the liquid that passes through the medium, leaving the cake on the medium. Drilling muds are tested to determine filtration rate and filter-cake properties. Cake properties such as cake thickness, toughness, slickness and permeability are important because the cake that forms on permeable zones in the wellbore can cause stuck pipe and other drilling problems. Reduced oil and gas production can result from reservoir damage when a poor filter cake allows deep filtrate invasion. A certain degree of cake buildup is desirable to isolate formations from drilling fluids. In openhole completions in high-angle or horizontal holes, the formation of an external filter cake is preferable to a cake that forms partly inside the formation. The latter has a higher potential for formation damage. A breaker is generally defined as a chemical that reduces the viscosity of a fluid by breaking long-chain molecules into shorter segments. Drilling fluids are commonly emulsified or contain long-chain molecules that have sufficient viscosity to carry cuttings to surface. After the drilling fluid has done its job, a breaker may be added to reduce the viscosity of the fluid by breaking down the long chain molecules into shorter molecules. A surfactant may be added to an emulsion to reduce its viscosity. The various fluids used in creating existing filtercakes are diverse and known in the art, and many, if not all, of these filtercakes formed downhole comprise acid-soluble and/or starch-based fluid loss control agents, for example, xanthan and/or starch, or other polysaccharides or polymers.

Therefore, in one aspect, the invention relates generally to the construction of an oil, gas condensate, or gas well using in the downhole or reservoir section, a reservoir drilling fluid or drill-in fluid (RDF) formulated conventionally but with the addition of one or more filtercake breakers which are inactive or relatively so until the time comes to complete the well and turn it on to production of the oil, gas condensate, or gas, whereupon it is desirable to activate the breaker and break the filtercake. In addition to this aspect of the invention (1) that involves a novel RDF formulation including said delayed breakers, the invention relates further to (2) a process of formulating the RDF, (3) a process of employing said RDF to lay down a filtercake which incorporates the inactive or relatively inactive filtercake breakers therein, (4) a process of completing the well by conventional means augmented by a step of deploying with the appropriate timing into the vicinity of the filtercake containing the breakers, a source of microwave, visible, uV, soft x-ray, or other electromagnetic radiation, (5) energizing said source of microwave, visible, uV, soft x-ray, or other electromagnetic radiation to activate said filtercake breakers downhole, and (6) displacing the residue of the broken filtercake so that it will not subsequently interfere with the facile production of the oil, gas condensate, or gas from the well.

More specifically, the invention relates to the downhole activation of filtercake breakers during said completion of the construction of the well. By incorporating inactive, delayed, or sequestered breakers into the filtercake laid down from the reservoir drilling fluid, and later activating them downhole, a much more complete and effective removal of the filtercake can be effected, leading to the delivery of a more productive well having a lower “skin factor”.

2. Background Art

There is relatively little teaching to be found in the prior art as to incorporating inactive, delayed, or sequestered breakers into the filtercake laid down from a reservoir drilling fluid, and later activating the breakers downhole, leading to a much more complete and effective removal of the filtercake and, as a result, delivering a more productive well having a lower skin factor.

In U.S. Patent Application No. 20070298978 (Dec. 27, 2007), entitled, “Compositions and Methods for Controlling Fluid Loss”, Crews, et al., teach that alkaline earth metal compounds may be fluid loss control (FLC) agents for viscoelastic surfactant (VES) fluids used for fluid loss control pills, lost circulation material pills, and kill pills in hydrocarbon recovery operations. The FLC agents may include, but not be limited to oxides and hydroxides of alkaline earth metals, and in one case magnesium oxide where the particle size of the magnesium oxide is between 1 nanometer to 0.4 millimeter. The FLC agent may alternatively be transition metal oxides and/or transition metal hydroxides. The FLC agent appears to associate with the VES micelles and together form a novel pseudo-filtercake quasi-crosslinked viscous fluid layer that limits further VES fluid flow into the porous media. The FLC agent solid particles may be added along with VES fluids. The pills may also contain internal breakers to reduce the viscosity thereof so that the components of the pill may be recovered.

In U.S. Patent Application No. 20070272409 (Nov. 29, 2007), entitled, “Energized Fluid for Generating Self-Cleaning Filtercake”, Growcock teaches a process for generating and subsequently breaking a filtercake, including dissolving a non-reactive gas in a wellbore fluid to form an energized fluid; pumping the energized fluid into a formation at a downhole pressure, wherein the pumping is at overbalanced conditions; producing a filtercake; and decreasing the down hole pressure to below a cut point of the dissolved gas in the energized fluid to form a vapor phase, wherein the vapor phase compromises the integrity of the filtercake.

In U.S. Patent Application No. 20060278389 entitled, “Fluid Loss Additive for Enhanced Fracture Clean-up”, and U.S. Pat. No. 7,337,839 (Mar. 4, 2008), of the same title, Ayoub, et al., teach a hydraulic fracturing method that includes designing a fracture treatment including a fluid pumping schedule to fracture a subterranean formation according to a design model that accounts for cumulative filtercake thickness, including polymer concentrated at the fracture surfaces, to provide a propped fracture width effectively greater than the cumulative filtercake thickness, and injecting fluids through a wellbore into the formation essentially according to the fluid pumping schedule of the fracture treatment design. A fracturing method is also disclosed that includes placing a high breaker loading in the filtercake. A composition is disclosed which comprises a fluid viscosified with a polymer and a fluid loss additive comprising a delayed breaker.

In U.S. Patent Application No. 20060157248 (Jul. 20, 2006) and U.S. Pat. No. 7,398,826 (Jul. 15, 2008), entitled, “Well Treatment with Dissolvable Polymer”, Hoefer, et al., teach a well treatment that includes injecting a well treatment fluid with insoluble polyol polymer such as polyvinyl alcohol (PVOH) dispersed therein, depositing the insoluble polymer in the wellbore or an adjacent formation, and thereafter dissolving the polymer by reducing salinity and/or increasing temperature conditions in the environment of the polymer deposit. The method is disclosed for filtercake formation, fluid loss control, drilling, hydraulic fracturing and fiber assisted transport, where removal of the polyol at the end of treatment or after treatment is desired. The method is also disclosed for providing dissolved polyol as a delayed breaker in crosslinked polymer viscosified systems and viscoelastic surfactant systems. Also disclosed are well treatment fluids containing insoluble amorphous or at least partially crystalline polyol, and a PVOH fiber composition wherein the fibers are stabilized from dissolution by salinity.

In U.S. Patent Application No. 20050130845 (Jun. 16, 2005), and U.S. Pat. No. 6,818,594 (Nov. 16, 2004), entitled, “Method for the Triggered Release of Polymer-Degrading Agents for Oil Field Use”, Freeman, et al., teach methods and related compositions for altering the physical and chemical properties of a substrate used in hydrocarbon exploitation, such as in downhole drilling operations. In a preferred embodiment a method involves formulating a fluid, tailored to the specific drilling conditions, that contains one or more inactivated enzymes. Preferably the enzyme is inactivated by encapsulation in a pH responsive material. After the fluid has been introduced into the well bore, one or more triggering signals, such as a change in pH, is applied to the fluid that will activate or reactivate the inactivated enzyme, preferably by causing it to be released by the encapsulation material. The reactivated enzyme is capable of selectively acting upon a substrate located downhole to bring about the desired change in the chemical or physical properties of the substrate.

In U.S. Pat. Nos. 5,981,447 (Nov. 9, 1999), 6,165,947 (Dec. 26, 2000), and 6,342,467 (Jan. 29, 2002), all three entitled, “Method and Composition for Controlling Fluid Loss in High Permeability Hydrocarbon Bearing Formations”, Chang, et al., teach a chemical system and method to stop or minimize fluid loss during completion of wells penetrating hydrocarbon formations. The invention relates to formulating a highly stable crosslinked hydroxyethyl cellulose (HEC), control released viscosity reduction additives, and user friendly packaging. The chemical system contains a linear HEC polymer solution, a low solubility compound which slowly raises the fluid pH, a chelating agent which further increases the pH level beyond the equilibrium achievable by the low solubility compound, a metal crosslinker which crosslinks HEC at elevated pH, a crosslink delaying agent which allows fluid viscosity to remain low until the fluid reaches the subterranean formation, and optionally an internal breaker. The chemical additives are packaged as an integrated pallet and transported to a field location which allows operators to conveniently mix them before pumping. There is also provided a dry granulated crosslinked polysaccharide for use as a fluid loss control agent.

In U.S. Pat. No. 7,231,976 (Jun. 19, 2007), and U.S. Pat. No. 7,392,844 (Jul. 1, 2008), both entitled, “Method of Treating an Oil or Gas Well with Biodegradable Low Toxicity Fluid System”, Berry, et al., teach a method of treating a well by introducing into the wellbore a biodegradable fluid system containing a blend of lactic acid ester, such as ethyl lactate, and a fatty acid ester, such as methyl soyate. The fluid system may be further in the form of a microemulsion that is formed by combining a blend with one or more emulsifiers, an alcohol, and water. The fluid system may be used in displacement, well remediation and stimulation as well as additional, alternative applications such as the cleaning of surface and/or downhole equipment.

In U.S. Pat. No. 7,422,060 (Sep. 9, 2008), entitled, “Methods and Apparatus for Completing a Well”, Hammami, et al., teach methods and tools to reduce sanding including the steps of fracturing the cement sheath in a localized zone around the casing and having the fractured zone act as sand filter between the formation and openings in the casing, with the openings being best pre-formed but temporarily blocked so as to allow a conventional primary cementing of the casing. The fracturing step can also be used for remedial operation to reopen blocked formation or screens.

In U.S. Pat. No. 5,587,296 (Dec. 24, 1996) entitled, “Reagent for Assaying Glucose”, Tsubota, et al., teach a reagent for assaying glucose, which comprises a first liquid reagent having a pH of 7.5 to 9.5 and containing at least either glucokinase or hexokinase, glucose 6-phosphate dehydrogenase, and adenosine 5′-triphosphate and a second liquid reagent having a pH of 3 to 5 and containing the oxidized form of nicotinamide adenine dinucleotide phosphate. The reagent can be stored as such stably for long in or out of contact with light at normal or low temperatures, so that it can be stored for long in the site of clinical examination and applied to an automatic analyzer without the necessity for dissolution prior to use. Tsubota, et al., provide a useful teaching for purposes of the present invention.

In U.S. Pat. No. 5,332,727 (Jul. 26, 1994), entitled, “Stable, Ingestable and Absorbable NADH and NADPH Therapeutic Compositions”, Birkmayer, teaches a stable, ingestable and intestine-absorbable therapeutic composition comprising NADH or NADPH, or physiologically acceptable salts thereof, in a pill form. The pill has an outer surface covered by an acid stable protective coating. This oral form of NADH/NADPH may be taken for a variety of known therapeutic effects, including the treatment of Parkinson's Disease and Morbus Alzheimer (i.e., Alzheimer's Disease), as well as in the treatment of mental depression.

Birkmayer also provides a teaching that is useful for purposes of the present invention. What Birkmayer teaches involves the reduced forms of NADH and NADPH, rather than the oxidized form of NADP⁺, as in the present invention and in U.S. Pat. No. 5,587,296 by Tsubota, et al.

Sometimes the drilling fluids that are laying down the filtercakes that subsequently need to be broken will be water-based; sometimes, they will be polyol-, oil-, or synthetic-oil-based. Even in the oil- or synthetic-oil-based drilling fluid cases, the filtercakes will include some water; and in the polyol-based drilling fluid cases, the filtercake will include some polyols that contain pendant —OH groups capable of reacting to deliver hydrogen peroxide, alkyl-, aryl-, alkaryl-, or aralkyl-hydroperoxide, or alkyl-, aryl-, alkaryl-, or aralkyl-peroxide or other activated oxygen-containing species.

Accordingly it is desired to utilize and appropriately expand upon the teachings of U.S. Pat. Nos. 5,587,296 and 5,332,727 in a novel and unexpected manner—namely in the use of radiation to activate previously inactive filtercake breakers with the proper timing during the course of the otherwise conventional completion of the construction of an oil, gas condensate, or gas well.

The above-cited references are incorporated herein by reference.

### SUMMARY OF INVENTION

It is an object of the invention to provide a reservoir drilling fluid that is conventional in every respect except that it also contains reagents, such as, for example, the oxidized form of nicotinamide adenine dinucleotide phosphate (NADP⁺) in solution form and in a form adsorbed onto finely divided calcium carbonate. In only one technology among the prior patents or published applications cited in the previous section, that of Freeman, et al., is there any use of an initially inactivated filtercake breaker, an enzyme. But this technology employs an externally applied change in pH to activate or reactivate the inactivated enzyme. All too often, enzymes become inactivated irreversibly. Accordingly, there remains a need for methods for utilizing microwave, visible, uV, soft x-ray, or other electromagnetic radiation to trigger the activation of an inactive, delayed, or sequestered breaker in the filtercake laid down from the reservoir drilling fluid along with an optional filtercake breaker activator chemical. The exposure to microwave, visible, uV, soft x-ray, or other electromagnetic radiation of a filtercake breaker activator chemical such as, for example, the oxidized form of NADP in contact with water (which becomes the activated filtercake breaker) supplies the necessary energy required to drive a chemical reaction wherein the NADP pulls hydrogen atoms away from the water, leaving the water remnants in a highly reactive form which leads to the downhole production of strong oxidants like peroxides or O₂. These highly reactive water remnants—strong oxidants—are the sought-for breakers not initially active (and in a certain sense, not even present initially), but which, upon the application of the radiation, become active toward degrading the xanthan, starch, or other polysaccharides or polymers present in the filtercake.

The present invention pertains to a novel reservoir drilling fluid or drill-in fluid (RDF) that is conventional in most ways but includes at least one filtercake breaker which is inactive or relatively so until the time comes to complete the well and turn it on to production of the oil, gas condensate, or gas, whereupon it is desirable to activate the breaker and break the filtercake; a process of formulating the novel RDF, a process of employing said RDF to lay down a filtercake which incorporates the inactive or relatively inactive filtercake breakers therein, a process of completing the well by largely conventional means augmented by a step of deploying with the appropriate timing into the vicinity of the filtercake containing the breakers, a source of electromagnetic radiation, a process of energizing said source of electromagnetic radiation to activate said filtercake breakers downhole, and a process of displacing the residue of the broken filtercake so that it will not subsequently interfere with the facile production of the oil, gas condensate, or gas from the well.

In one embodiment, the reservoir drilling fluid (RDF) of the present invention contains conventional components, such as, a base fluid; a gelling agent or rheological additive; a fluid-loss control agent; and a weighting agent (and the like). In this embodiment, the conventional RDF is modified to include an inactive, delayed, or sequestered breaker chemical or an activator for said inactive, delayed, or sequestered breaker chemical, wherein the breaker chemical may be activated directly or indirectly by radiation.

Additionally, according to the teachings of the present invention, conventional processes of formulating a conventional RDF are modified to include the new step of adding an inactive, delayed, or sequestered breaker chemical or an activator for said inactive, delayed, or sequestered breaker chemical, wherein the breaker chemical may be activated directly or indirectly by radiation.

In another embodiment, there is also disclosed a downhole wellbore filtercake breaker comprising one or more breaker chemicals capable of being activated with radiation to form one or more breaker reaction products which in turn are capable of reacting with the filtercake to chemically break down the filtercake. The filtercake typically comprises acid-soluble and/or starch-based fluid loss control agents. These one or more breaker chemicals are capable of being activated with radiation to form one or more oxygen-containing species that will degrade and/or depolymerize xanthan and/or starch, or other polysaccharides or polymers contained in the filtercake.

In yet another embodiment, there is disclosed a downhole wellbore filtercake breaker comprising one or more breaker chemicals, and one or more breaker activators. The breaker activators are capable of being activated with radiation to form one or more activator reaction products which in turn activate the breaker chemicals. The breaker chemicals are capable of being activated by the activator reaction products to form one or more breaker reaction products which in turn are capable of reacting with the filtercake to chemically break down the filtercake. Typically, the filtercake comprises acid-soluble and/or starch-based fluid loss control agents.

In another embodiment of the present invention there is described a process of completing a well by largely conventional means augmented by a step of deploying with the appropriate timing into the vicinity of the filtercake a source of microwave, visible, uV, soft x-ray, or other electromagnetic radiation to activate at least one previously inactive, delayed, or sequestered breaker chemical. In one embodiment, the source of electromagnetic radiation is energized to activate the filtercake breakers downhole. In another embodiment, the source of electromagnetic radiation is energized to activate the filtercake breakers downhole by means of reactions (such as, for example, the Reactions 1 and 2 set forth herein) which utilize at least one previously inactive, delayed, or sequestered breaker chemical to degrade components of the filtercake. The breaker chemical reagents can be regenerated and optionally may be reused upon the application of at least one additional pulse of electromagnetic radiation to degrade components of the filtercake. As an additional step, the residue of the broken filtercake can be displaced so that it will not subsequently interfere with the facile production of the oil, gas condensate, or gas from the well.

There is also disclosed a method of breaking a downhole filtercake formed in a wellbore comprising the steps of: (a) deploying a source of radiation into a wellbore containing filtercake, wherein the filtercake contains at least one chemical breaker (or activator for the at least one chemical breaker) capable of being activated with radiation to form one or more products capable of reacting with the filtercake to cause the filtercake to chemically break down; (b) energizing the source of radiation proximate the filtercake to activate the chemical breaker(s) (or activator(s) for the chemical breaker(s)) into one or more breaker reaction products; and (c) permitting the breaker reaction product(s) to react with the filtercake to chemically break down the filtercake into filtercake break down product(s). This method can further comprise the additional step of permitting the filtercake break down products to react with the one or more breaker reaction products to regenerate the at least one chemical breaker (or breaker activator). Additionally, the method may include the step of energizing the source of radiation to subject the regenerated chemical breaker(s) (or breaker activator(s)) to the energized radiation. In one embodiment where the filtercake comprises xanthan and/or starch, or other polysaccharides or polymers, the breaker reaction product(s) serve as downhole reagents capable or degrading and/or de-polymerizing the xanthan and/or starch, or other polysaccharides or polymers contained in the filtercake. In another embodiment where the filtercake comprises xanthan and/or starch, or other polysaccharides or polymers, the chemical breaker(s) or breaker activator(s) serve as a catalyst which utilizes water and the energized radiation to decompose and/or depolymerize the xanthan and/or starch, or other polysaccharides or polymers contained in the filtercake into the filtercake breakdown products, and further comprises the steps of: regenerating at least some of the catalyst via a reduction reaction in the presence of the filtercake breakdown products, and repeating the step of energizing the source of radiation to again subject the catalyst(s) to the energized radiation. The practice of this method can also include the additional step of removing from the wellbore the filtercake break down products, and/or the step of displacing the filtercake break down products to facilitate production of oil, gas condensate, or gas from the wellbore.

Another embodiment includes a method for creating and removing a downhole filtercake formed in a wellbore comprising the steps of: (a) introducing into the wellbore a fluid for forming a filtercake in the wellbore, wherein the fluid comprises at least one chemical breaker (or activator for the chemical breaker(s)) capable of being activated with radiation to form one or more products capable of reacting with the filtercake to cause the filtercake to chemically break down; (b) permitting the filtercake to form in the wellbore; (c) deploying a source of radiation into the wellbore; (d) energizing, at a desired time subsequent to the formation of the filtercake, the source of radiation proximate to the filtercake to activate the chemical breaker(s) (or activator(s) for the chemical breaker(s)) into one or more breaker reaction products; (e) permitting the breaker reaction product(s) to react with the filtercake to chemically break down the filtercake into filtercake break down product(s). This method may include the additional step of permitting the filtercake break down products to react with the breaker reaction product(s) to regenerate the chemical breaker(s). Also, this method may further comprise the step of subjecting the regenerated chemical breaker(s) to the energized source of radiation. The practice of this method can also include the additional step of removing from the wellbore the filtercake break down product(s), and/or the step of displacing the filtercake break down products to facilitate production of oil, gas condensate, or gas from the wellbore. The filtercake forming fluid employed in this method may be a water-based drill-in fluid, or reservoir drilling fluid, fluid loss control pill, well treatment fluid, hydraulic fracturing fluid or fiber assisted transport fluid. Sometimes the fluids will be water-based, sometimes, polyol-, oil-, or synthetic-oil-based; but in all cases they will include some water or —OH-containing groups and those moieties will be incorporated into the filtercakes, from whence the reactions or catalytic reactions of the present invention can lead to activated oxygen-containing species that will degrade the binding components of the filtercakes and break them down.

In various embodiments described herein, the source of radiation can be selected from the group consisting of: microwave, visible, uV, soft x-ray, or other electromagnetic radiation. The microwave and lower energy visible electromagnetic radiation may require two-photon or multi-photon reaction sequences in order to produce activated oxygen-containing species of sufficient activity to succeed in breaking down a filtercake.

In various embodiments described herein, the chemical breakers, breaker activators, the inactive breaker chemicals, delayed breaker chemicals, or sequestered breaker chemicals, include at least one of selected from the group consisting of: water, an alcohol, a polyol, and any member of the family of chemicals referred to as duroquinones. Sometimes the drilling fluids will be water-based, sometimes, polyol-, oil-, or synthetic-oil-based; but in all cases they will include some water or —OH-containing groups and those moieties will be incorporated into the filtercakes, from whence the reactions or catalytic reactions of the present invention can lead to activated oxygen-containing species that will degrade the binding components of the filtercakes and break them down.

In other embodiments described herein, the chemical breakers, breaker activators, the inactive breaker chemicals, delayed breaker chemicals, or sequestered breaker chemicals include at least one of: a duroquinone; tetraalkyl-p-benzoquinone; 1,4,5,8-tetrahydro-2,3,6,7-tetramethyl-9,10(9h,10h)-anthracenedione; decyl-plastoquinone; 2-(12-hydroxydodeca-5,10-diynyl)-3,5,6-trimethyl-p-benzoquinone; 2,3,5,6-tetramethyl-1,4 benzoquinone; tetramethyl-p-benzoquinone; a pyrophosphatase nucleotide from crotalus adamanteus venom; a phosphodiesterase 3′:5′-cyclic nucleotide-specific from bovine brain; 1-methylnicotinic acid amide chloride; 3-carbamoyl-1-(cyanomethyl)pyridinium chloride; 1-benzyl-3-carbamoyl-pyridinium chloride; 1-butyl-3-carbamoylpyridinium bromide; 1-benzyl-3-methylcarbamoyl-pyridinium chloride; 1-methylnicotinamide iodide; 3-hydrazinocarbonyl-1-methyl-pyridinium iodide; 1-benzyl-3-carbamoyl-pyridinium bromide; a beta-nicotinamide mononucleotide; an alpha-nicotinamide adenine dinucleotide; nicotinamide 1,N6-ethenoadenine; 1,N6-ethenonicotinamide adenine dinucleotide; 1,N6-etheno-NAD; 3-carbamoyl-1-(2-hydroxyethyl) pyridinium chloride; 1-acetonyl-3-carbamoyl pyridinium chloride; 3-carbamoyl-1-(carbamoylmethyl)-pyridinium chloride; 3-carbamoyl-1-propylpyridinium bromide; 1-benzyl-3-carbamoyl-pyridinium chloride; 1-benzyl-3-carbamoyl-pyridinium chloride; 1-carbamoylmethyl-3-diethylcarbamoyl-pyridinium chloride; 1-(2-carbamoylethyl)-3-(diethylcarbamoyl)pyridinium chloride; and 1-carbamoylmethyl-3-(4-chlorophenylcarbamoyl)pyridinium chloride; or the like.

If required, the chemical breakers, breaker activators, the inactive breaker chemicals, delayed breaker chemicals, or sequestered breaker chemicals are first derivatized to make them oil-soluble or are first derivatized to make them water-, alcohol-, polyol-, or brine-soluble.

### DETAILED DESCRIPTION OF INVENTION

The first embodiment of the present invention is a composition of matter produced when a compositionally rather conventional reservoir drilling fluid or drill-in fluid (RDF) is formulated to include also at least one filtercake breaker which is inactive or relatively inactive during the period of formulation and deployment of said RDF (and which may be nothing more than simply water) up until the time when the filtercake therefrom has been laid down and it comes time to complete the well and turn it on to production of the oil, gas condensate, or gas, whereupon it is desirable to utilize at least one of the filtercake breaker activators which may also be present in the filtercake to activate the breaker and break the filtercake.

Examples are given below of inactive, delayed, or sequestered breaker chemicals or of activators for said inactive, delayed, or sequestered breaker chemicals, suitable for incorporating into the filtercake laid down from the reservoir drilling fluid and subsequently activated by exposure to microwave, visible, uV, soft x-ray, or other electromagnetic radiation to react with available water molecules, alcohols, or polyols, leaving the water, alcohol, or polyol, remnants in a highly reactive form which leads to the production of strong oxidants like peroxides and/or free O₂. These highly reactive water, alcohol, or polyol, remnants—strong oxidants—are the sought-for breakers not initially active, but which, upon the application of the radiation, become active toward degrading the xanthan, starch, or other polysaccharides or polymers present in the filtercake or become active toward activating water, alcohol, or polyol, or the remnants or reaction products thereof to become active toward degrading the xanthan, starch, or other polysaccharides or polymers present in the filtercake. Said examples of inactive, delayed, or sequestered breaker chemicals or of activators for said inactive, delayed, or sequestered breaker chemicals, include water, an alcohol, a polyol, any member of the family of chemicals referred to as duroquinones, such as, for example, tetraalkyl-p-benzoquinone, 2,3,5,6-tetramethyl-1,4 benzoquinone; tetramethyl-p-benzoquinone; Sigma-Aldrich (SA) Catalogue Number D223204, under the chemical name Duroquinone, with the chemical formula C₁₀H₁₂O₂, (available from the Sigma-Aldrich Corporation, 3050 Spruce Street, St. Louis, Mo. 63103); Sigma-Aldrich Cat. No. S793280, 1,4,5,8-Tetrahydro-2,3,6,7-Tetramethyl-9,10(9H,10H)-Anthracenedione, C₁₈H₂₀O₂; SA Cat. No. D7786, Decyl-Plastoquinone, C₁₈H₂₈O₂; SA Cat. No. A3711, 2-(12-Hydroxydodeca-5,10-diynyl)-3,5,6-trimethyl-p-benzoquinone, C₂₁H₂₆O₃; SA Cat. No. P7383, Pyrophosphatase, Nucleotide Type II from Crotalus adamanteus venom; SA Cat. No. P9529, Phosphodiesterase 3′:5′-Cyclic Nucleotide-specific from bovine brain; SA Cat. No. M4627, 1-Methylnicotinic Acid Amide Chloride, C₇H₉N₂OCl; SA Cat. No. S914274, 3-Carbamoyl-1-(Cyanomethyl) Pyridinium Chloride, C₈H₈ClN₃O; SA Cat. No. S246506, 1-Benzyl-3-Carbamoyl-Pyridinium Chloride, C₁₃H₁₃ClN₂O; SA Cat. No. S400343, 1-Butyl-3-Carbamoylpyridinium Bromide, C₁₀H₁₃BrN₂O; SA Cat. No. S328294, 1-Benzyl-3-Methylcarbamoyl-Pyridinium Chloride, C₁₄H₁₅ClN₂O; SA Cat. No. M4752, 1-Methylnicotinamide Iodide, C₇H₉₁N₂O; SA Cat. No. S242934, 3-Hydrazinocarbonyl-1-Methyl-Pyridinium Iodide, C₇H₁₀₁N₃O; SA Cat. No. S915173, 1-Benzyl-3-Carbamoyl-Pyridinium Bromide, C₁₃H₁₃BrN₂O; SA Cat. No. N3501, Beta-Nicotinamide Mononucleotide, C₁₁H₁₅N₂O₈P; SA Cat. No. N6754, Alpha-Nicotinamide Adenine Dinucleotide, C₂₁H₂₆N₇NaO₁₄P₂; SA Cat. No. N2630, Nicotinamide 1,N6-Ethenoadenine, or 1,N6-EthenoNicotinamide Adenine Dinucleotide, or 1,N6-Etheno-NAD, C₂₃H₂₇N₇O₁₄P₂; SA Cat. No. S914436, 3-Carbamoyl-1-(2-Hydroxyethyl) Pyridinium Chloride, C₈H₁₁ClN₂O₂; SA Cat. No. S914444, 1-Acetonyl-3-Carbamoyl Pyridinium Chloride, C₉H₁₁ClN₂O₂; SA Cat. No. S400165, 3-Carbamoyl-1-(Carbamoylmethyl)-Pyridinium Chloride, C₈H₁₀ClN₃O₂; SA Cat. No. S906239, 3-Carbamoyl-1-Propylpyridinium Bromide, C₉H₁₃BrN₂O; SA Cat. No. S246506, 1-Benzyl-3-Carbamoyl-Pyridinium Chloride, C₁₃H₁₃ClN₂O; SA Cat. No. S205753, 1-Benzyl-3-Carbamoyl-Pyridinium Chloride, C₁₃H₁₃ClN₂O; SA Cat. No. R433616, 1-Carbamoylmethyl-3-Diethylcarbamoyl-Pyridinium Chloride, C₁₂H₁₈ClN₃O₂; SA Cat. No. S343277, 1-(2-Carbamoylethyl)-3-(Diethylcarbamoyl) Pyridinium Chloride, C₁₃H₂₀ClN₃O₂; and Sigma-Aldrich Cat. No. S400939, 1-Carbamoylmethyl-3-(4-Chlorophenylcarbamoyl) Pyridinium Chloride, C₁₄H₁₃Cl₂N₃O₂ or the like. Some of the water-, alcohol-, polyol-, or brine-soluble compounds listed above, such as, for example, Alpha-Nicotinamide Adenine Dinucleotide, may need to be derivatized to make them oil-soluble, such as, for example, substituting t-butyl groups onto several of the functional groups that can be alkylated. And some of the oil-soluble compounds listed above, such as, for example, 1,4,5,8-Tetrahydro-2,3,6,7-Tetramethyl-9,10(9H,10H)-Anthracenedione, may need to be derivatized to make them water-, alcohol-, polyol-, or brine-soluble, such as, for example, to 1,5-Dihydro-2,3,6,7-Tetramethyl-4,8,-di-(carboxylate, alkali metal salt)-9,10(9H,10H)-Anthracenedione.

A second embodiment in accordance with the present invention is a process for formulating said novel RDF by augmenting the formulation of a conventional RDF with the addition of components as detailed above. Conventional water-containing RDF's are complex fluids whose main functions are notably to participate in cleaning the well during drilling or after it has been drilled (completion fluids), apply a sufficient hydraulic pressure to ensure the safety of the well, stabilize the well walls, lubricate the casing strings or drill strings, or enable equipment to be set up at the bottom or the production process to be implemented (completion fluids). To fulfill these functions, the base fluid, water in this case, has specific products added to it to regulate the rheology, density, cleaning ability, and filtrate control, for example. Conventional water-containing RDF's (also referred to as conventional water-containing mud formulations proposed for crossing reservoirs, more generally known as conventional “drill-in fluids” are described, for example, in the document “Drill-in Fluids Control Formation Damage” by Halliday W. S., World Oil, December 1994, 43-47, which document is incorporated by reference herein in its entirety.

Conventional oil-containing RDF's are often even more complex fluids than conventional water-containing RDF's in that the base fluids for oil-containing RDF's usually contain both a substantial portion of oil as the continuous phase as well as a substantial portion of water, brine, alcohol, polyol, or polar organic solvent which are immiscible with said oil-continuous phase but are provided with a suitable package of emulsifying agents so that said substantial portion of water, brine, alcohol, polyol, or polar organic solvent will remain as a relatively stable dispersed phase within said oil-continuous phase. The main functions of oil-containing RDF's are largely the same as those of water-containing RDF's: to participate in cleaning the well during drilling or after it has been drilled, apply a sufficient hydraulic pressure to ensure the safety of the well, stabilize the well walls, lubricate the casing strings or drill strings, or enable equipment to be set up at the bottom or the production process to be implemented. To fulfill these functions, the base fluid, an oil-continuous dispersion in this case, has specific products added to it to regulate the rheology, density, cleaning ability, and filtrate control, for example.

In summary, the second embodiment in accordance with the present invention is a process wherein the formulation of a conventional water- or oil-based RDF is augmented with the addition of water-soluble or oil-soluble components as detailed above. In this embodiment, it may be desirable to introduce water-soluble components as detailed above into either water- or oil-based RDF's, producing novel and un-conventional RDF's. Furthermore, it may be desirable to introduce oil-soluble components as detailed above into either water- or oil-based RDF's, producing novel and un-conventional RDF's.

A third embodiment in accordance with the present invention is a process of employing said novel and un-conventional RDF's to lay down a filtercake which incorporates the inactive or relatively inactive filtercake breakers and optionally the filtercake breaker activators therein.

A fourth embodiment in accordance with the present invention is a process of completing a well by largely conventional means augmented by a step of deploying with the appropriate timing into the vicinity of the filtercake containing the filtercake breakers and/or optionally the filtercake breaker activators, a source of microwave, visible, uV, soft x-ray, or other electromagnetic radiation.

A fifth embodiment in accordance with the present invention is a process of energizing said source of microwave, visible, uV, soft x-ray, or other electromagnetic radiation to activate said filtercake breakers downhole by means of reactions, such as, for example, the following Reactions 1 and 2:

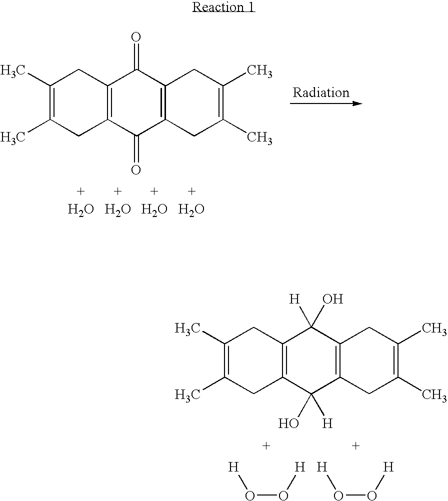

In the above Reaction 1, the reagent, 1,4,5,8-Tetrahydro-2,3,6,7-tetramethyl-9,10(9h,10h)-anthracenedione, is activated by radiation to abstract hydrogen atoms from water molecules, alcohols, or polyols, leaving the water molecule remnants (OH radicals), or the alcohol, or polyol molecule remnants (OR radicals), to reorganize themselves into hydrogen peroxide, alkyl-, aryl-, alkaryl-, or aralkyl-hydroperoxide, or alkyl-, aryl-, alkaryl-, or aralkyl-peroxide. Whether the OH or OR radicals reorganize in this way or form some other oxygen-containing species, it is clear that the hydrogen peroxide, alkyl-, aryl-, alkaryl-, or aralkyl-hydroperoxide, or alkyl-, aryl-, alkaryl-, or aralkyl-peroxide or other oxygen-containing species will be highly reactive toward degrading and depolymerizing the xanthan and/or starch, or other polysaccharides or polymers contained in the filtercake. Similarly, in the below Reaction 2, the reagent, β-Nicotinamide mononucleotide, is activated by radiation to abstract hydrogen atoms from water molecules, alcohols, or polyols, leaving the water molecule remnants (OH radicals), or the alcohol, or polyol molecule remnants (OR radicals), to reorganize themselves into hydrogen peroxide, alkyl-, aryl-, alkaryl-, or aralkyl-hydroperoxide, or alkyl-, aryl-, alkaryl-, or aralkyl-peroxide. Whether the OH or OR radicals reorganize in this way or form some other oxygen-containing species, it is clear that the hydrogen peroxide, alkyl-, aryl-, alkaryl-, or aralkyl-hydroperoxide, or alkyl-, aryl-, alkaryl-, or aralkyl-peroxide or other oxygen-containing species will be highly reactive toward degrading and depolymerizing the xanthan and/or starch, or other polysaccharides or polymers contained in the filtercake.

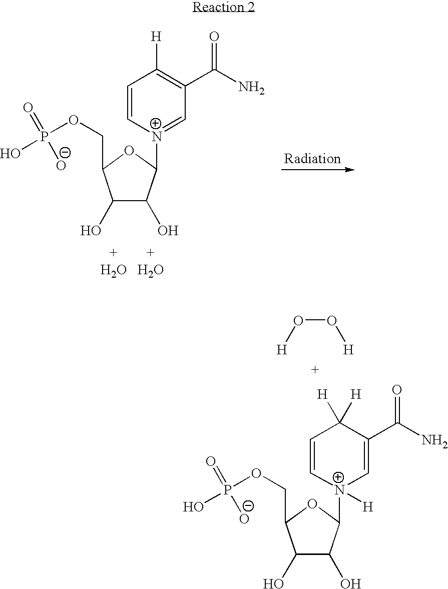

There are analogues to Reactions 1 and 2 that take place in non-aqueous conditions or when water molecules are deficient. In these analogues to Reactions 1 and 2, the OH radicals or nascent OH⁻ (the residuum of a water molecule immediately after an H⁺ has been abstracted therefrom), hydrogen peroxide, or nascent oxygen (the O or O₂ residua just after their formation from water molecules) may be absent; their roles as products of the analogues to Reactions 1 and 2 being replaced by similar products such as the alkyl-, aryl-, alkaryl-, or aralkyl-hydroperoxides, or alkyl-, aryl-, alkaryl-, or aralkyl-peroxides or some other highly reactive oxygen-containing species. Those skilled in the art, having benefit of this disclosure of the above example Reactions 1 and 2, will appreciate that other radiation-initiated reactions can be devised which can lead to the production downhole of reagents capable of degrading the xanthan and/or starch, or other polysaccharides or polymers contained in filtercakes, which other reactions do not, therefore, depart from the scope of the present invention.

And a sixth embodiment in accordance with the present invention is a process of displacing the residue of the broken filtercake so that it will not subsequently interfere with the facile production of the oil, gas condensate, or gas from the well.

Xanthan and/or starch, or other polysaccharide or polymer components of filtercakes will be decomposed and/or de-polymerized by their reaction with active oxygen-containing species, such as, for example, the OH radical, nascent OH⁻ (the residuum of a water molecule immediately after an H⁺ has been abstracted therefrom), hydrogen peroxide, other peroxy-containing species, and nascent oxygen (the O or O₂ residua just after their formation from water molecules, alcohols, or polyols by the reaction with some of the radiation-activated reagents in accordance with the present invention). Such decomposed and/or de-polymerized polysaccharide or other polymer residua will be relatively strong reducing agents which are capable of reacting with the products of reactions like Reactions 1 and 2, specifically, by means of reactions like the following Reactions 3 and 4:

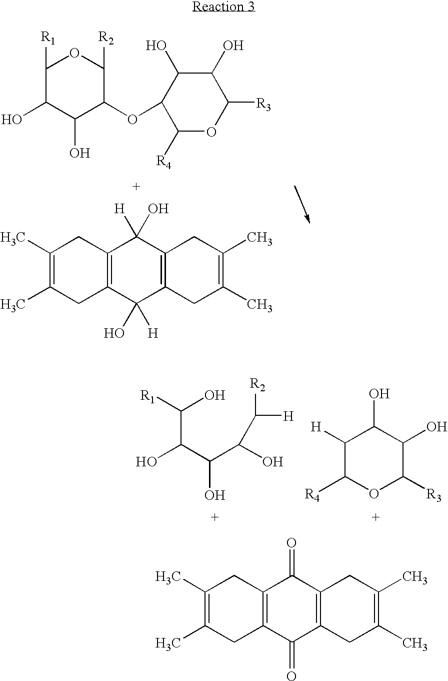

In the above Reaction 3, the hydrogenated product of Reaction 1, reacts reductively with a decomposed and/or de-polymerized polysaccharide or other polymer residuum to further decompose and/or de-polymerize the polysaccharide or other polymer residuum. Such reduction reactions will not repolymerize nor undecompose said previously decomposed or de-polymerized polysaccharide or other polymer residua.

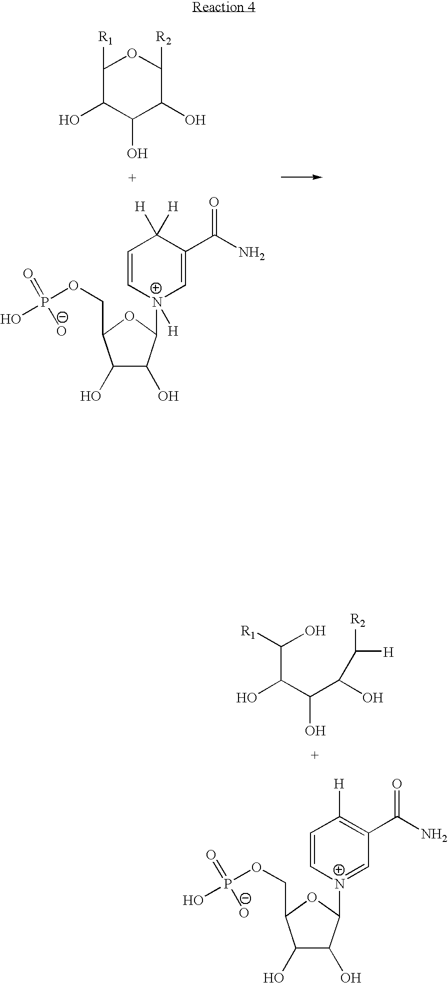

In the above Reaction 4, the hydrogenated product of Reaction 2, reacts reductively with a decomposed and/or de-polymerized polysaccharide or other polymer residuum to further decompose and/or de-polymerize the polysaccharide or other polymer residuum. Such reduction reactions will not repolymerize nor undecompose said previously decomposed and/or de-polymerized polysaccharide or other polymer residua.

Most importantly, while the reductions occurring in Reactions 3 and 4 further decompose and/or de-polymerize polysaccharide or other polymer residua, the connected oxidation occurring in Reaction 3 will regenerate the reagent, 1,4,5,8-Tetrahydro-2,3,6,7-tetramethyl-9,10(9h,10h)-anthracenedione that acts in Reaction 1, activated by radiation, to abstract hydrogen atoms from water molecules, alcohols, or polyols, and similarly, the oxidation occurring in Reaction 4 will regenerate the reagent, β-Nicotinamide mononucleotide, that acts in Reaction 2, activated by radiation, to abstract hydrogen atoms from water molecules, alcohols, or polyols. It will be obvious to one skilled in the art having the benefit of the teachings of the present invention, that in the combination of Reactions 1 and 3,1,4,5,8-Tetrahydro-2,3,6,7-tetramethyl-9,10(9h,10h)-anthracenedione is not acting as a reagent but as a catalyst which utilizes radiation and water to decompose and/or depolymerize polysaccharides like xanthan and starch or other polymers in filtercakes. Similarly, it will be obvious to one skilled in the art having the benefit of the teachings of the present invention that in the combination of Reactions 2 and 4, β-Nicotinamide mononucleotide is not acting as a reagent but as a catalyst which utilizes radiation and water to decompose and/or depolymerize polysaccharides like xanthan and starch or other polymers in filtercakes, which catalyst is at least partly regenerated at the end of a given cycle of exposure to radiation and the consequent degradation of components of the filter cake. Thus are incorporated herein by reference into the present invention, the teachings of U.S. Pat. No. 5,587,296, namely, that the filtercake may contain the oxidized form of nicotinamide adenine dinucleotide phosphate, or the like; and the teachings of U.S. Pat. No. 5,332,727, namely that the filtercake may contain the reduced forms of NADH and NADPH, or the like.

As set forth above, radiation-initiated reactions take place in aqueous conditions that lead to the production of downhole reagents capable of degrading and/or de-polymerizing the xanthan and/or starch, or other polysaccharides or polymers contained in the filtercake. Other analogous reactions exist that take place in non-aqueous conditions or when water molecules are somewhat deficient or when an alcohol or polyol is present to serve as the source of the activated oxygen atoms, activated oxygen molecules, hydroperoxides, hydrogen peroxide, or other peroxides. In these radiation-initiated reactions, at least one of the selected inactive, delayed, or sequestered breaker chemical or an activator for the inactive, delayed, or sequestered breaker chemical is activated by radiation to form oxygen-containing species that will be highly reactive toward degrading and/or depolymerizing the xanthan and/or starch, or other polysaccharides or polymers contained in the filtercake. The degraded and/or de-polymerized polysaccharide or other polymer residua will be relatively strong reducing agents that are capable of reacting further with the oxygen-containing species formed by the radiation-initiated reactions to further decompose and/or de-polymerize the polysaccharide and other polymer residuum into an end product that will not repolymerize or undecompose. During this further decomposition process, the connected oxidation that occurs during the reduction reactions will regenerate the selected inactive, delayed, or sequestered breaker chemical or an activator for said inactive, delayed, or sequestered breaker chemical so that it can again serve as a reagent which is activated by radiation to form oxygen-containing species that will be highly reactive toward degrading and/or depolymerizing the xanthan and/or starch, or other polysaccharides or polymers contained in the filtercake. In this manner, the selected inactive, delayed, or sequestered breaker chemical or an activator for said inactive, delayed, or sequestered breaker chemical is serving as a catalyst which utilized radiation and water to decompose and/or depolymerize the xanthan and/or starch, or other polysaccharides or polymers contained in the filtercake, and which catalyst is at least partly regenerated.

In one aspect of the present invention, a filtercake is formed in a wellbore where the filtercake comprises, in part, an inactive chemical breaker, a delayed chemical breaker, or a sequestered chemical breaker, all having the potential, once activated, to cause the breakdown of the filtercake. Additionally the filtercake can comprise, in part, a chemical activator compound, that once activated, can serve to activate the one or more inactive, delayed or sequestered filtercake breakers that are present in the filtercake to cause the breakdown of the filtercake. In one aspect of the present invention, an oxidizer (or activator chemical) is induced by radiation. The oxidizer essentially then takes on the role of a radiation-activated catalyst to initiate the filtercake breakdown process. The degredation products reduce the activator chemicals to their original form so that another burst of radiation can produce the whole sequence again. This reaction sequence, in effect, utilizes the activation chemicals in the role of radiation-activated catalyst, whereas the earlier reaction sequence utilizes the activation chemicals in the role of one-time reagents. The source of electromagnetic radiation is energized to activate the filtercake breakers downhole by means of reactions (such as, for example, the Reactions 1 and 2 set forth herein) which utilize at least one previously inactive, delayed, or sequestered breaker chemical to degrade components of the filtercake. The breaker chemical reagents can be regenerated and optionally may be reused upon the application of at least one additional pulse of electromagnetic radiation to again degrade components of the filtercake.

In United States Patent Application Publication No. US 2009/0260818A1 (Daniel et al.), entitled, “Microwave-based Downhole Activation Method For Wellbore Consolidation Applications,” there is disclosed a method and a tool for wellbore strengthening during drilling. Selected chemicals are mixed with the drilling fluid but do not react with it. The chemicals concentrate in the filtercake. A tool, which comprises a microwave source, is used to trigger downhole polymerization or crosslinking reactions within the filtercake downhole. The polymerization or crosslinking reactions results in a film or a gel that strengthens the wellbore. United States Patent Application Publication No. US 2009/0260818A1 is therefore incorporated into the present invention in its entirety even though it strives to increase the strength of a filtercake downhole, while the present invention strives to reactively or catalytically decrease the strength of a filtercake downhole.

Daniel et al., further provides that chemical modification of the mud filtercake will be dependent on the additives in the drilling fluid. For example, U.S. Pat. No. 4,768,593 and U.S. Pat. No. 4,760,882 disclose a drilling fluid which contains a polymeric material that, upon triggering by gamma rays or UV rays, can be crosslinked with a monomeric agent using a chemical initiator or a radioactive source, resulting in the conversion of drilling mud to cement. U.S. Pat. No. 6,848,519 discloses the modification of the mud filtercake to form a chemical casing while drilling. The drilling fluid has a pH between 6 and 10 and contains a polymer and a water-dispersible thermoset resin that crosslinks the polymer. The drilling fluid also contains a particulate thermoset resin and a delayed dispersible acid catalyst that crosslinks the particulate thermoset resin. The chemical modification of the filtercake, which cures into a hard and tough crosslinked chemical casing, is induced by pH and temperature via curing of the thermoset resin and the use of the delayed dispersible acid catalyst. Alternatively, instead of polymerization, cement hydration within a drilling fluid or filtercake, is also possible. U.S. Pat. No. 5,213,160, U.S. Pat. No. 5,476,144 and U.S. Pat. No. 5,464,060 disclose the addition of cement or blast furnace slag to a drilling fluid to provide a settable filtercake. U.S. Pat. No. 6,204,350 discloses cure-on-demand, moisture-curable compositions, used as sealants, putties and adhesives, which contain an acid generating material that can be selected from carboxylate esters or sulfonate esters, as well as onium salts capable of curing the composition. The acid is released upon exposure to heat, ultraviolet light, visible light, electron beam irradiation or microwave irradiation. Heat curable compositions used as seals, bonding materials and on tape, and that are controllably curable by microwave energy, are described in WO 01/28771. US20060047028 discloses curing seal compositions containing a hydrogel polymer and a base material that can be polymerized in-situ by microwave irradiation, and EP0933498 discloses rapidly consolidating particulates material coated with hardenable resins in wells. U.S. Pat. No. 6,214,175 also describes recovery of gas hydrates using microwave radiation. Microwave sources are also present in tools for measuring standoff from the borehole wall as is described in US 2006/0065394. These references are also incorporated herein in their entirety.

A stated object of Daniel et al., is to provide techniques for strengthening the borehole wall during drilling and so extend the intervals between casing setting operations. The object of the present invention, however, is to use or adapt such downhole ultraviolet light, visible light, electron beam irradiation or microwave irradiation-type tools to weaken and break the filtercake. The microwave tool of Daniel et al., represents an example of a device that could be used in accordance with the present invention for generating electromagnetic radiation downhole to, as in the present disclosure, activate filtercake breakers. One such tool described by Daniel et al. comprises a tool body; a source of microwave radiation located in the tool body; and means for irradiating the borehole wall with microwave radiation from the source; wherein the means for irradiating the borehole wall comprises an antenna that can be positioned near to the borehole wall, and the source is operable to initiate polymerization or cross-linking in a chemical system in a filter cake on the borehole wall (or in the case of the present invention, to initiate the activation of filtercake breakers). The tool preferably comprises at least one arm mounted on the tool body, the microwave antenna being mounted at the end of the arm. The arm can be extendible, and a preferred embodiment comprises multiple arms spaced axially and or azimuthally on the tool body. Each arm can carry an antenna that is connected to the microwave source.

The advantage of using microwave irradiation, such as with the device described in Daniel et al., is that it can produce a high rate of heating. Once the microwave source is switched on, high temperatures can be reached within seconds and the reaction can start almost instantaneously. Therefore chemical modification via polymerization or crosslinking (or in the present case, activation of a filtercake breaker) can be achieved in much shorter periods of time when compared to using conventional heating methods. According to Daniel et al., the risk of degradation due to the high temperatures generated by the microwave irradiation is minimized by enabling the microwave source within the tool to be switched on or switched off. One of ordinary skill in the art, having the benefit of the present disclosure, could substitute for such a microwave-generating tool either a visible-light-generating tool, a uV-generating tool, or an x-ray-generating tool for use in the filtercake breaking applications of the present disclosure.

Just as at a given moment in the day, a green plant utilizes chlorophyll, visible light, water and CO₂ to produce simple sugars (part of which is utilized in the respiratory functions of the plant) and oxygen (part of which is excreted and part is utilized in the respiratory functions of the plant), so one of the embodiments of the present invention utilizes chlorophyll-like chemicals, microwave-, visible-, uV-, or x-ray-light, and water to produce activated oxygen-containing species—hydrogen peroxide, alkyl-, aryl-, alkaryl-, or aralkyl-hydroperoxide, or alkyl-, aryl-, alkaryl-, or aralkyl-peroxide or other oxygen-containing species—which will be highly reactive toward degrading and depolymerizing the xanthan and/or starch, or other polysaccharides or polymers contained in a filtercake.

Just as yesterday, a green plant utilized chlorophyll, visible light, water and CO₂ to produce simple sugars and oxygen, then last night there were chemical pathways provided in the cell to regenerate the chlorophyll to its original chemical configuration of yesterday so that today the cycle can be repeated, so one of the embodiments of the present invention utilizes chlorophyll-like chemicals, microwave-, visible-, uV-, or x-ray-light, and water to produce activated oxygen-containing species for degrading and depolymerizing the polymers in a filtercake, then a dark period ensues during which the chlorophyll-like chemicals react with partially degraded residues in the filtercake to regenerate the chlorophyll-like chemicals to their original chemical configurations of earlier so that the cycle can be repeated.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A downhole wellbore filtercake breaker comprising one or more breaker chemicals capable of being activated with radiation to form one or more breaker reaction products which in turn are capable of reacting with the filtercake to chemically break down the filtercake, said filtercake comprising acid-soluble and/or starch-based fluid loss control agents.

2. The filtercake breaker of claim 1 wherein said one or more breaker chemicals is capable of being activated with radiation to form one or more oxygen-containing species that will degrade and/or depolymerize xanthan and/or starch, or other polysaccharides or polymers contained in the filtercake

3. The filtercake breaker of claim 1, wherein said one or more breaker chemicals include at least one of: water, an alcohol, a polyol.

4. The filtercake breaker of claim 1, wherein said one or more breaker chemicals include at least one of: a duroquinone, a tetraalkyl-p-benzoquinone, 1,4,5,8-tetrahydro-2,3,6,7-tetramethyl-9,10(9h,10h)-anthracenedione; decyl-plastoquinone; 2-(12-hydroxydodeca-5,10-diynyl)-3,5,6-trimethyl-p-benzoquinone; 2,3,5,6-tetramethyl-1,4 benzoquinone; tetramethyl-p-benzoquinone; a pyrophosphatase nucleotide from crotalus adamanteus venom; a phosphodiesterase 3′:5′-cyclic nucleotide-specific from bovine brain; 1-methylnicotinic acid amide chloride; 3-carbamoyl-1-(cyanomethyl)pyridinium chloride; 1-benzyl-3-carbamoyl-pyridinium chloride; 1-butyl-3-carbamoylpyridinium bromide; 1-benzyl-3-methylcarbamoyl-pyridinium chloride; 1-methylnicotinamide iodide; 3-hydrazinocarbonyl-1-methyl-pyridinium iodide; 1-benzyl-3-carbamoyl-pyridinium bromide; a beta-nicotinamide mononucleotide; an alpha-nicotinamide adenine dinucleotide; nicotinamide 1,N6-ethenoadenine; 1,N6-ethenonicotinamide adenine dinucleotide; 1,N6-etheno-NAD; 3-carbamoyl-1-(2-hydroxyethyl)pyridinium chloride; 1-acetonyl-3-carbamoyl pyridinium chloride; 3-carbamoyl-1-(carbamoylmethyl)-pyridinium chloride; 3-carbamoyl-1-propylpyridinium bromide; 1-benzyl-3-carbamoyl-pyridinium chloride; 1-benzyl-3-carbamoyl-pyridinium chloride; 1-carbamoylmethyl-3-diethylcarbamoyl-pyridinium chloride; 1-(2-carbamoylethyl)-3-(diethylcarbamoyl)pyridinium chloride; 1-carbamoylmethyl-3-(4-chlorophenylcarbamoyl)pyridinium chloride.

5. The filtercake breaker of claim 4, wherein said one or more breaker chemicals is first derivatized to make it oil-soluble or is first derivatized to make it water-, alcohol-, polyol-, or brine-soluble.

6. A downhole wellbore filtercake breaker comprising:
a. one or more breaker chemicals, and
b. one or more breaker activators capable of being activated with radiation to form one or more activator reaction products which in turn activate said one or more breaker chemicals,
said one or more breaker chemicals capable of being activated by said one or more activator reaction products to form one or more breaker reaction products which in turn are capable of reacting with the filtercake to chemically break down the filtercake,
said filtercake comprising acid-soluble and/or starch-based fluid loss control agents.

7. The filtercake breaker of claim 6, wherein said one or more breaker activators include at least one of: a duroquinone, a tetraalkyl-p-benzoquinone, 1,4,5,8-tetrahydro-2,3,6,7-tetramethyl-9,10 (9h, 10h)-anthracenedione; decyl-plastoquinone; 2-(12-hydroxydodeca-5,10-diynyl)-3,5,6-trimethyl-p-benzoquinone; 2,3,5,6-tetramethyl-1,4 benzoquinone; tetramethyl-p-benzoquinone; a pyrophosphatase nucleotide from crotalus adamanteus venom; a phosphodiesterase 3′:5′-cyclic nucleotide-specific from bovine brain; 1-methylnicotinic acid amide chloride; 3-carbamoyl-1-(cyanomethyl)pyridinium chloride; 1-benzyl-3-carbamoyl-pyridinium chloride; 1-butyl-3-carbamoylpyridinium bromide; 1-benzyl-3-methylcarbamoyl-pyridinium chloride; 1-methylnicotinamide iodide; 3-hydrazinocarbonyl-1-methyl-pyridinium iodide; 1-benzyl-3-carbamoyl-pyridinium bromide; a beta-nicotinamide mononucleotide; an alpha-nicotinamide adenine dinucleotide; nicotinamide 1,N6-ethenoadenine; 1,N6-ethenonicotinamide adenine dinucleotide; 1,N6-etheno-NAD; 3-carbamoyl-1-(2-hydroxyethyl)pyridinium chloride; 1-acetonyl-3-carbamoyl pyridinium chloride; 3-carbamoyl-1-(carbamoylmethyl)-pyridinium chloride; 3-carbamoyl-1-propylpyridinium bromide; 1-benzyl-3-carbamoyl-pyridinium chloride; 1-benzyl-3-carbamoyl-pyridinium chloride; 1-carbamoylmethyl-3-diethylcarbamoyl-pyridinium chloride; 1-(2-carbamoylethyl)-3-(diethylcarbamoyl)pyridinium chloride; 1-carbamoylmethyl-3-(4-chlorophenylcarbamoyl)pyridinium chloride.

8. The filtercake breaker of claim 7, wherein said one or more breaker activators is first derivatized to make it oil-soluble or is first derivatized to make it water-, alcohol-, polyol-, or brine-soluble.

9. A reservoir drilling fluid, comprising:
a. a base fluid;
b. a gelling agent or rheological additive;
c. a fluid-loss control agent;
d. a weighting agent; and
e. an inactive, delayed, or sequestered breaker chemical or an activator for said inactive, delayed, or sequestered breaker chemical, wherein the breaker chemical may be activated directly or indirectly by radiation.

10. The reservoir drilling fluid of claim 9, wherein the inactive, delayed, or sequestered breaker chemical includes at least one of water, an alcohol, and a polyol.

11. The reservoir drilling fluid of claim 9, wherein the inactive, delayed, or sequestered breaker chemical or activator therefor includes at least one of a duroquinone, a tetraalkyl-p-benzoquinone, 1,4,5,8-tetrahydro-2,3,6,7-tetramethyl-9,10 (9h,10h)-anthracenedione; decyl-plastoquinone; 2-(12-hydroxydodeca-5,10-diynyl)-3,5,6-trimethyl-p-benzoquinone; 2,3,5,6-tetramethyl-1,4 benzoquinone; tetramethyl-p-benzoquinone; a pyrophosphatase nucleotide from crotalus adamanteus venom; a phosphodiesterase 3′:5′-cyclic nucleotide-specific from bovine brain; 1-methylnicotinic acid amide chloride; 3-carbamoyl-1-(cyanomethyl)pyridinium chloride; 1-benzyl-3-carbamoyl-pyridinium chloride; 1-butyl-3-carbamoylpyridinium bromide; 1-benzyl-3-methylcarbamoyl-pyridinium chloride; 1-methylnicotinamide iodide; 3-hydrazinocarbonyl-1-methyl-pyridinium iodide; 1-benzyl-3-carbamoyl-pyridinium bromide; a beta-nicotinamide mononucleotide; an alpha-nicotinamide adenine dinucleotide; nicotinamide 1,N6-ethenoadenine; 1,N6-ethenonicotinamide adenine dinucleotide; 1,N6-etheno-NAD; 3-carbamoyl-1-(2-hydroxyethyl)pyridinium chloride; 1-acetonyl-3-carbamoyl pyridinium chloride; 3-carbamoyl-1-(carbamoylmethyl)-pyridinium chloride; 3-carbamoyl-1-propylpyridinium bromide; 1-benzyl-3-carbamoyl-pyridinium chloride; 1-benzyl-3-carbamoyl-pyridinium chloride; 1-carbamoylmethyl-3-diethylcarbamoyl-pyridinium chloride; 1-(2-carbamoylethyl)-3-(diethylcarbamoyl)pyridinium chloride; and 1-carbamoylmethyl-3-(4-chlorophenylcarbamoyl)pyridinium chloride; or the like.

12. The reservoir drilling fluid of claim 11, wherein the inactive, delayed, or sequestered breaker chemical or activator therefor is first derivatized to make it oil-soluble or is first derivatized to make it water-, alcohol-, polyol-, or brine-soluble.

13. A method of breaking a downhole filtercake formed in a wellbore comprising the steps of:
a. deploying a source of radiation into a wellbore containing filtercake, wherein the filtercake contains at least one chemical breaker (or activator for said at least one chemical breaker) capable of being activated with radiation to form one or more products capable of reacting with the filtercake to cause the filtercake to chemically break down;
b. energizing said source of radiation proximate the filtercake to activate said at least one chemical breaker (or activator for said at least one chemical breaker) into one or more breaker reaction products; and
c. permitting said one or more breaker reaction products to react with the filtercake to chemically break down the filtercake into filtercake break down products.

14. The method of claim 13 further comprising the additional step of permitting said filtercake break down products to react with said one or more breaker reaction products to regenerate said at least one chemical breaker (or breaker activator).

15. The method of claim 14, further comprising the step of energizing said source of radiation to subject said regenerated at least one chemical breaker (or breaker activator) to said energized radiation.

16. The method of claim 13 wherein said filtercake comprises, xanthan and/or starch, or other polysaccharides or polymers and wherein said breaker reaction products serve as downhole reagents capable or degrading and/or de-polymerizing said xanthan and/or starch, or other polysaccharides or polymers contained in said filtercake.

17. The method of claim 13 wherein said filtercake comprises, xanthan and/or starch, or other polysaccharides or polymers and wherein said chemical breaker or breaker activator serves as a catalyst which utilizes water and said energized radiation to decompose and/or depolymerize said xanthan and/or starch, or other polysaccharides or polymers contained in said filtercake into said filtercake breakdown products, and further comprises the steps of: regenerating at least some of said catalyst via a reduction reaction in the presence of said filtercake breakdown products and repeating the step of energizing said source of radiation to again subject said catalyst to said energized radiation.

18. The method of claim 13 further comprising the step of removing from the wellbore said filtercake break down products.

19. The method of claim 13 further comprising the step of displacing said filtercake break down products to facilitate production of oil, gas condensate, or gas from said wellbore.

20. The method of claim 13 wherein said source of radiation is selected from the group consisting of: microwave, visible, uV, soft x-ray, or other electromagnetic radiation.

21. A method for creating and removing a downhole filtercake formed in a wellbore comprising the steps of:
a. introducing into the wellbore a fluid for forming a filtercake in said wellbore, said fluid comprising at least one chemical breaker (or activator for said at least one chemical breaker) capable of being activated with radiation to form one or more products capable of reacting with said filtercake to cause said filtercake to chemically break down;
b. permitting said filtercake to form in said wellbore;
c. deploying a source of radiation into said wellbore;
d. energizing, at a desired time subsequent to the formation of said filtercake, said source of radiation proximate to said filtercake to activate said at least one chemical breaker (or activator for said at least one chemical breaker) into one or more breaker reaction products; and
e. permitting said one or more breaker reaction products to react with the filtercake to chemically break down the filtercake into filtercake break down products.

22. The method of claim 21 further comprising the step of permitting said filtercake break down products to react with said one or more breaker reaction products to regenerate said at least one chemical breaker.

23. The method of claim 22 further comprising the step of subjecting said regenerated at least one chemical breaker to said energized source of radiation.

24. The method of claim 21 wherein said source of radiation is selected from the group consisting of: microwave, visible, uV, soft x-ray, or other electromagnetic radiation.

25. The method of claim 21 further comprising the step of removing from the wellbore said filtercake break down products.

26. The method of claim 21 wherein said fluid is a water-based drill-in fluid, or reservoir drilling fluid, fluid loss control pill, well treatment fluid, hydraulic fracturing fluid or fiber assisted transport fluid.
